(19) United States
(12) Patent Application Publication
(10) Pub. No.: US 2011/0173638 A1
(43) Pub. Date: Jul. 14, 2011

(54) EVENT NOTIFYING APPARATUS AND EVENT NOTIFYING METHOD

(75) Inventor: Midori Nakamae, Tokyo (JP)

(73) Assignee: Kabushiki Kaisha Toshiba, Tokyo (JP)

(21) Appl. No.: 12/917,269

(22) Filed: Nov. 1, 2010

(30) Foreign Application Priority Data
Jan. 8, 2010 (JP) 2010-003291

(51) Int. Cl. G06F 9/46

(52) U.S. Cl. 719/318

(57) ABSTRACT

An event notifying apparatus includes: an extracting module configured to extract a periodically occurring event from acquired input data or a communication history; a predicting module configured to predict a future occurrence time of the event based on a cycle of occurrence of the event extracted by the extracting module; and a notifying module configured to notify an external device about the event based on the future occurrence time predicted by the predicting module.

### CROSS-REFERENCE TO THE RELATED APPLICATION(S)

The present application is based upon and claims priority from prior Japanese Patent Application No. 2010-003291, filed on Jan. 8, 2010, the entire contents of which are incorporated herein by reference.

### FIELD

Embodiments described herein generally relate to an event notifying apparatus and an event notifying method capable of providing event management and notification of related information.

### BACKGROUND

In recent years, information processing apparatus which handle digital data etc. have spread widely. However, such information processing apparatus are insufficient in terms of a reminder function.

For example, JP-A-2005-100300 discloses a technique for providing a shopping site environment with a reminder function of sending an e-mail to a destination specified by a registered member over a computer network as a reminder of an important day that was input by the registered member a certain number of days (specified by the registered member) before that day. This technique also makes it possible, using a reminder, to refer to goods that were sent in the past as well as to order a present.

However, the technique described in JP-A-2005-100300 is such that a user himself or herself registers a date and time of an event. That is, in the conventional technique described in JP-A-2005-100300, it is difficult to automatically extract a future event from photographs taken by the user or mail transmission/reception data.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram showing a configuration of an information processing apparatus (personal computer) which is an embodiment of the event notifying apparatus according to the present invention.

FIG. 2 is a flowchart of a process that is executed by the information processing apparatus according to the embodiment.

FIG. 3 shows an example event classification dictionary used in the embodiment.

FIG. 4 shows an event history management table used in the embodiment.

FIG. 5 shows a preference information management table-1 used in the embodiment.

FIG. 6 shows a preference information management table-2 used in the embodiment.

FIG. 7 shows a preference information management table-3 used in the embodiment.

FIG. 8 shows an example event occurrence time classification dictionary used in the embodiment.

FIG. 9 shows a future event management table-1 used in the embodiment.

FIG. 10 shows a future event management table-2 used in the embodiment.

FIG. 11 shows a future event management table-3 used in the embodiment.

FIG. 12 shows an example manner (example-1) of notifying the user of an event in the information processing apparatus according to the embodiment.

FIG. 13 shows an example manner (example-2) of notifying the user of an event in the information processing apparatus according to the embodiment.

FIG. 14 shows an example manner (example-3) of notifying the user of an event in the information processing apparatus according to the embodiment.

FIG. 15 is a flowchart of a process for generating or updating a/the event history management table in the embodiment.

FIG. 16 is a flowchart of a process for generating or updating a/the preference information management table in the embodiment.

FIG. 17 is a flowchart of a process for generating or updating a/the future event management table in the embodiment.

FIG. 18 is a flowchart of a process for calculating event importance and updating the future event management table in the embodiment.

### DETAILED DESCRIPTION

According to the embodiments described herein, there is provided an event notifying apparatus including: an extracting module configured to extract a periodically occurring event from acquired input data or a communication history; a predicting module configured to predict a future occurrence time of the event based on a cycle of occurrence of the event extracted by the extracting module; and a notifying module configured to notify an external device about the event based on the future occurrence time predicted by the predicting module.

Embodiments according to the present invention will be described in detail with reference to the accompanying drawings. The scope of the claimed invention should not be limited to the examples illustrated in the drawings and those described in below.

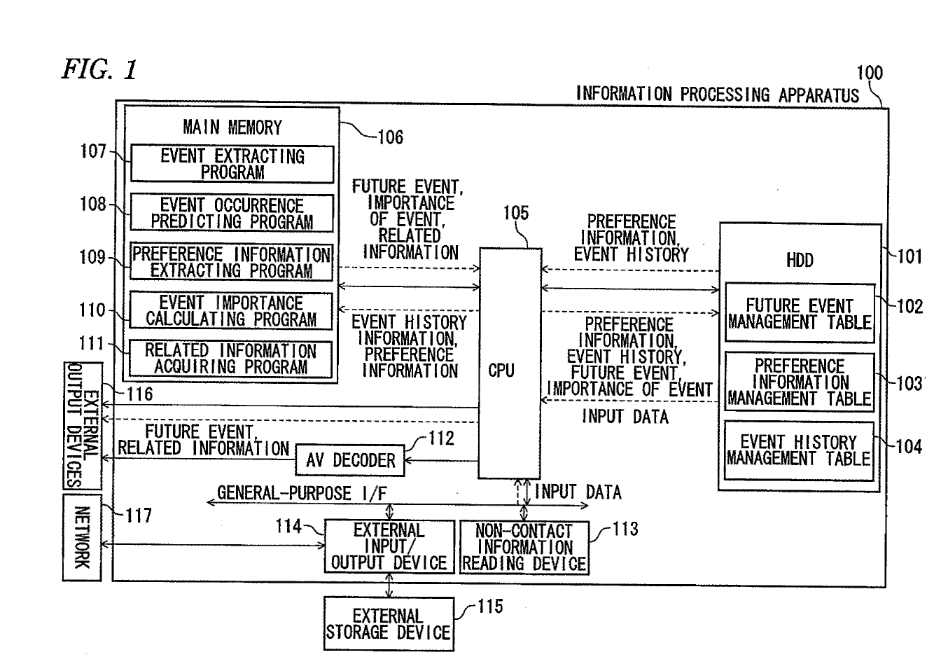

FIG. 1 is a block diagram showing a configuration of an information processing apparatus 100 (personal computer) which is an embodiment of the event notifying apparatus according to the invention. Although in the embodiment the event notifying apparatus according to the invention is a personal computer, it may be an HDD recorder, a DVD recorder, a TV receiver, or the like having the same essential features as the personal computer according to the embodiment.

The information processing apparatus 100 includes an HDD 101, a CPU 105, a main memory 106, an AV decoder 112, a non-contact information reading device 113, and an external input/output device 114.

Referring to FIG. 1, the CPU 105, which is a processor for controlling the apparatus 100 and external output devices 116, runs an OS and various programs that are loaded into the main memory 106 from the HDD 101. An event extracting program 107, an event occurrence predicting program 108, a preference information extracting program 109, an event importance calculating program 110, and a related information acquiring program 111 are loaded into the main memory 106 as individual programs. The CPU 105 incorporates a memory controller for access-controlling the main memory 106, a controller for controlling the AV decoder 112, a controller for controlling the non-contact information reading device 113, a controller for controlling the HDD 101, a controller for controlling the external input/output device 114, and a controller for controlling the external output devices 116.

The HDD 101 is stored with the OS and the various programs which are necessary for operation of the information processing apparatus 100. In the embodiment, the HDD 101 is stored with an event history management table 104, a preference information management table 103, and a future event management table 102.

The event history management table 104 contains event-related data that were generated by the user and extracted by the event extracting program 107 and event-related data that were generated by the user and extracted by the event extracting program 107 via the non-contact information reading device 113.

The preference information management table 103 contains pieces of user preference information that were extracted by the preference extracting program 109 and data that were extracted by the preference extracting program 109 via the CPU 105 and the non-contact information reading device 113.

The future event management table 102 contains future events for which future event occurrence times were predicted by the event occurrence predicting program 108 based on extracted pieces of event information.

The external input/output device 114 is a device for connection to a network 117 such as the Internet and an external storage device 115 such as an SD card, a USB flash memory, or an external HDD.

The non-contact information reading device 113 receives a getting on/off station name and settlement history information from a cell phone, a credit card, or the like that incorporates a non-contact IC chip.

Each external output device 116 outputs video data or audio data that is output from the AV decoder 112 and event information and related information that are output from the CPU 105.

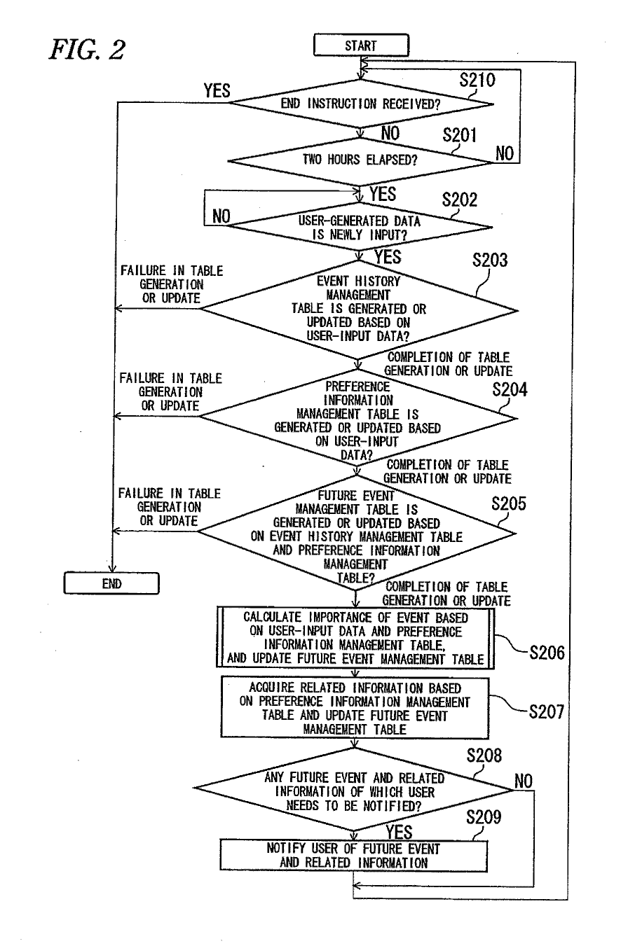

FIG. 2 is a flowchart of a process that is executed by the information processing apparatus 100 according to the embodiment, and will be described later in the section “Operation of the embodiment”.

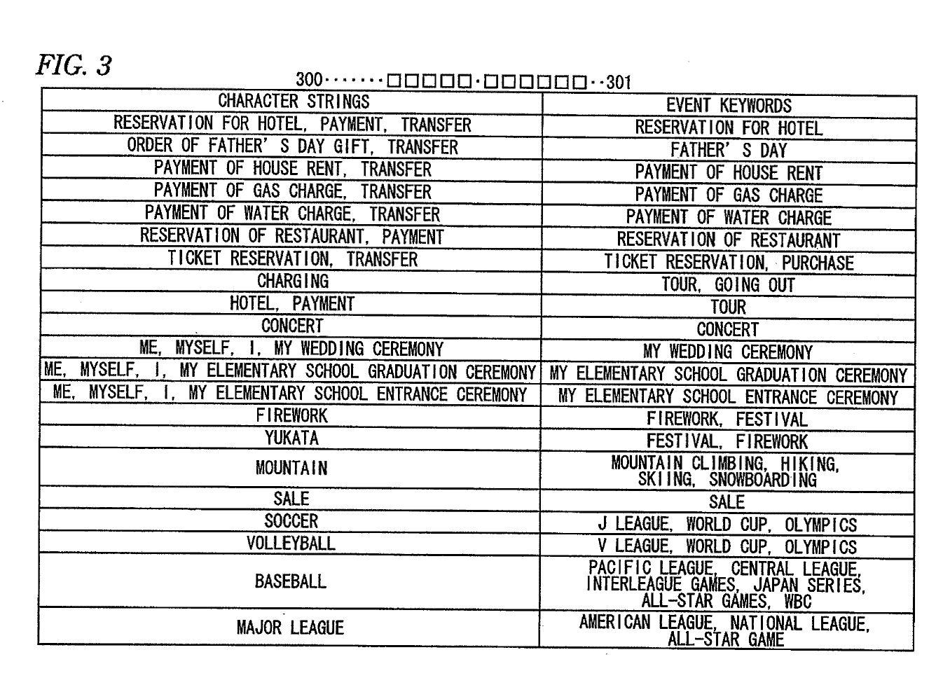

FIG. 3 shows an example event classification dictionary which is stored in advance as a database in the main memory 106 and held by the event extracting program 107. This event classification dictionary includes columns “character string” 300 and “event keywords” 301. If a character string that is extracted by analyzing user-generated input data coincides with a character string in the dictionary, the event keyword corresponding to the match-found character string in the dictionary is stored in the event history management table 104.

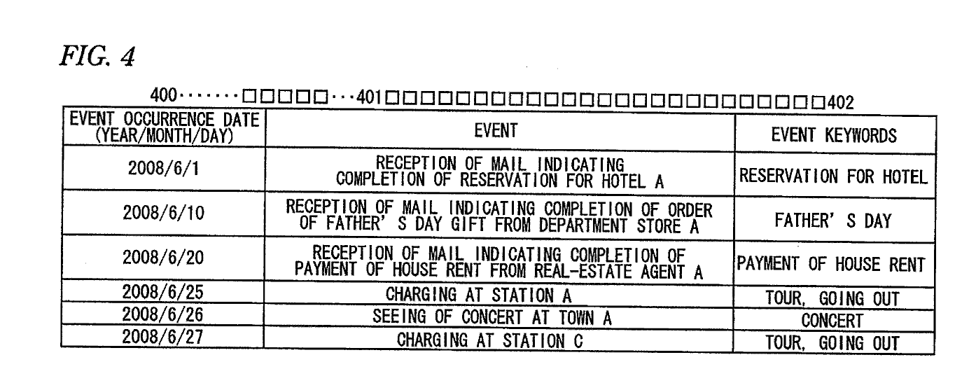

FIG. 4 shows the event history management table 104 which is stored in the HDD 101 and managed by the event extracting program 107. The table 104 consists of columns “event occurrence date” (year/month/day) 400, “event” 401, and “event keywords” 402.

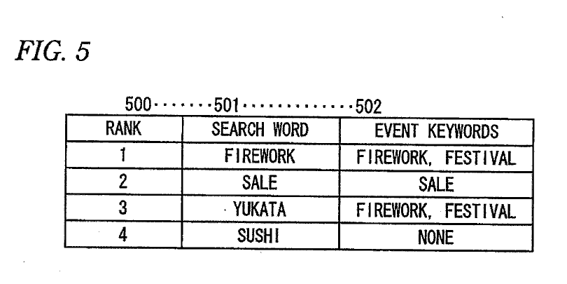

FIG. 5 shows a preference information management table-1 which is stored in the HDD 101 and managed by the preference information extracting program 109. The preference information management table-1 is a table that was produced in such a manner that an Internet search history of the user was extracted by the event extracting program 107 from the network 117 via the external input/output device 114 and search words having top-four numbers of searches were picked up. The preference information management table-1 consists of columns “rank” 500, “search word” 501, and “event keywords” 502.

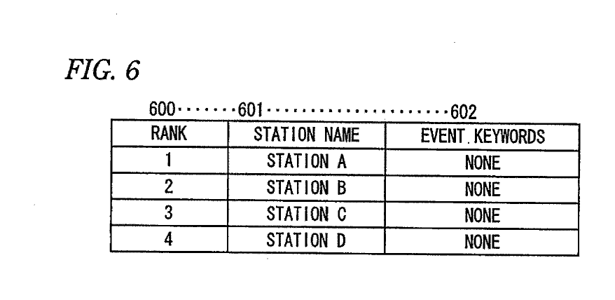

FIG. 6 shows a preference information management table-2 which is stored in the HDD 101 and managed by the preference information extracting program 109. The preference information management table-2 is a table that was produced in such a manner that the names of getting on/off stations of the user were extracted by the event extracting program 107 via the non-contact information reading device 113 and station names having top-four numbers of times of getting-on/off were picked up. The preference information management table-2 consists of columns “rank” 600, “station name” 601, and “event keywords” 602.

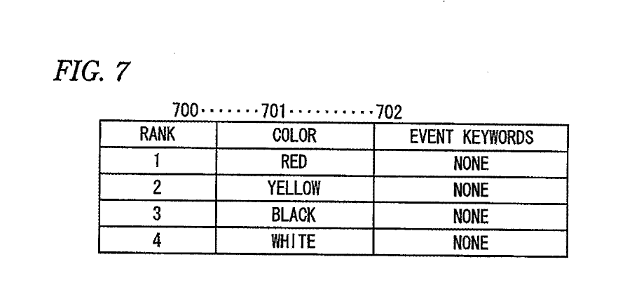

FIG. 7 shows a preference information management table-3 which is stored in the HDD 101 and managed by the preference information extracting program 109. The preference information management table-3 is a table that was produced in such a manner that moving image data that were input via the external input/output device 114 were analyzed, frequently occurring colors were extracted by the event extracting program 107, and colors having top-four numbers of times of occurrence were picked up. The preference information management table-3 consists of columns “rank” 700, “color” 701, and “event keywords” 702.

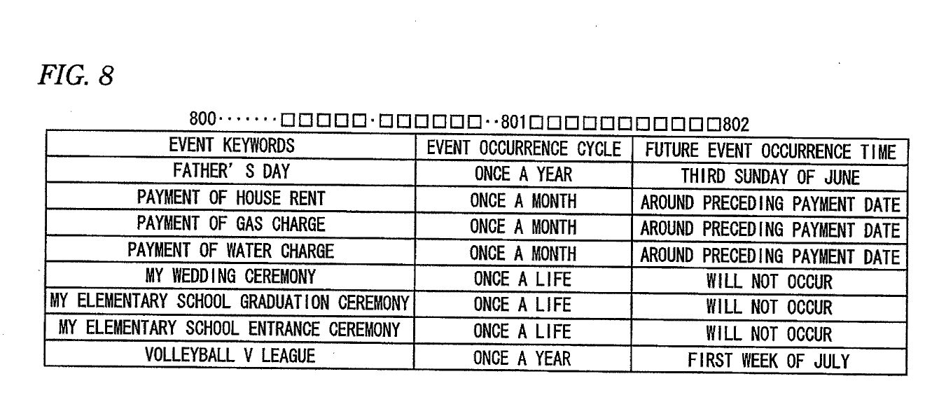

FIG. 8 shows an example event occurrence time classification dictionary which is stored in the main memory 106 and held by the event occurrence predicting program 108. This event occurrence time classification dictionary includes columns “event keywords” 800, “event occurrence cycle” 801, and “future event occurrence time” 802.

If a match is found between an event keyword contained in the event history management table 104 or the preference information management table 103 and an event keyword contained in this dictionary, a/the future event management table 102 is generated or updated.

If no match is found, a search is performed using the network 117 to determine future event occurrence times based on event keywords.

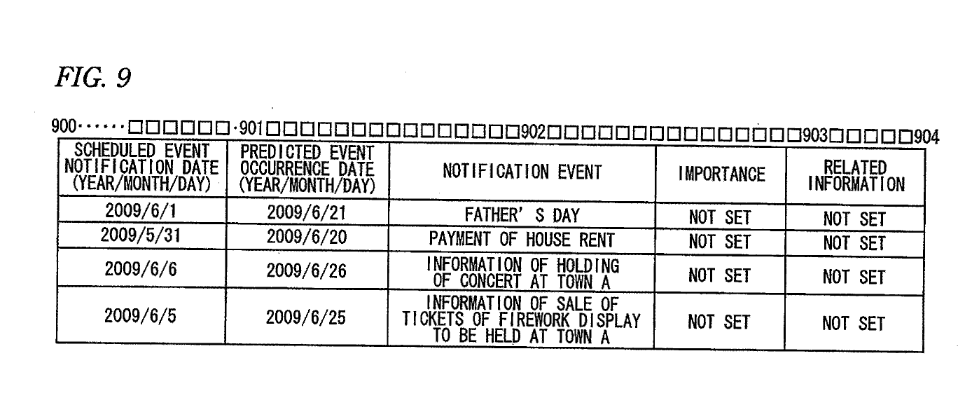

FIG. 9 shows a future event management table-1 which is stored in the HDD 101 and managed by the event occurrence predicting program 108. The future event management table-1 is used for managing results of the event occurrence predicting program 108's extracting periodically occurring events from the events managed by the event history management table 104 and predicting future event occurrence times or results of the event extracting program 107's searching the network 117 for future event occurrence times via the external input/output device 114. The future event management table-1 consists of columns “scheduled event notification date (year/month/day)” 900, “predicted event occurrence date (year/month/day)” 901, “notification event” 902, “importance” 903, and “related information” 904.

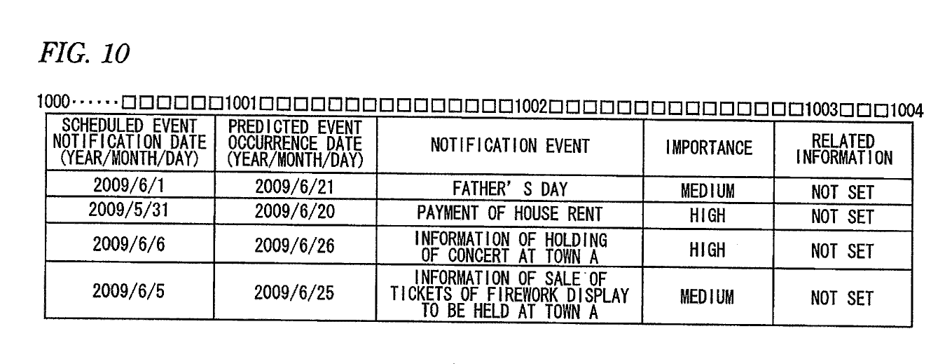

FIG. 10 shows a future event management table-2 which is stored in the HDD 101 and updated by the event importance calculating program 110. The future event management table-2 has the same structure as the future event management table-1 which is managed by the event occurrence predicting program 108 via the CPU 105. When an event is added, the event occurrence predicting program 108 determines importance of the event based on event-related data of the user that is input from the network 117 or the external storage device 115 via the external input/output device 114 and updates the entry in a column “importance” 1003.

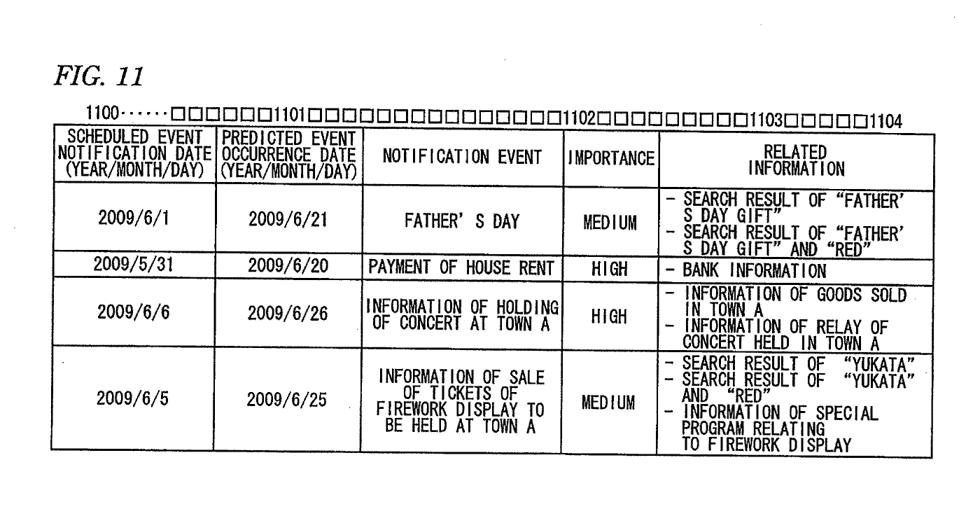

FIG. 11 shows a future event management table-3 which is stored in the HDD 101 and updated by the event importance calculating program 110. The future event management table-3 has the same structure as the future event management table-1 which is managed by the event occurrence predicting program 108 via the CPU 105. When an event is added, the event occurrence predicting program 108 searches the network 117 for information relating to the event via the external input/output device 114 based on user preference information contained in the preference information management tables 103 and updates the entry in a column “related information” 1104.

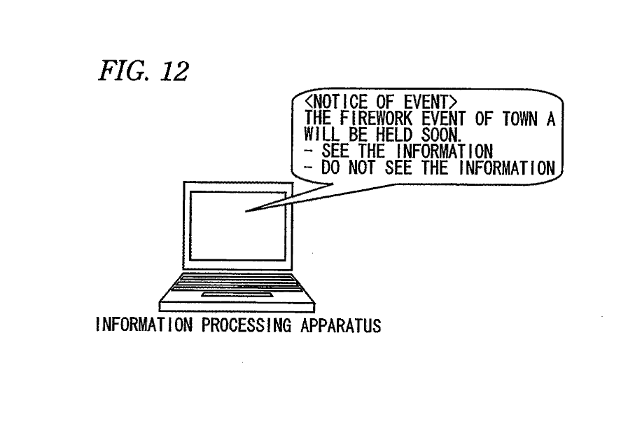

FIG. 12 shows a display example-1 of the information processing apparatus 100 according to the embodiment. This example is such that the information processing apparatus 100 displays a message on the display device via the CPU 105 to send a notice of an event on a scheduled event notification date in the future event management table 102 which is managed by the event occurrence predicting program 108.

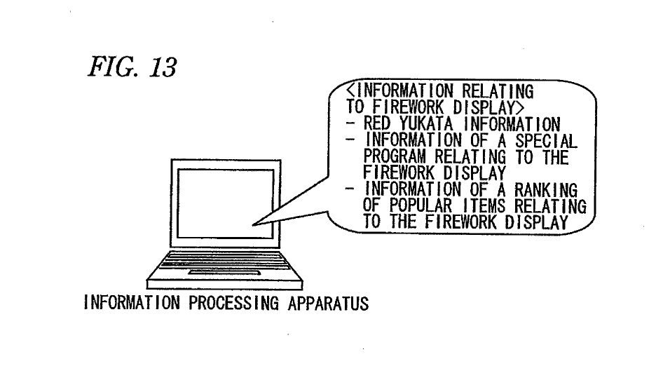

FIG. 13 shows a display example-2 of the information processing apparatus 100 according to the embodiment. This example is such that corresponding related information is sent when the user selects the item “See the information” in the display example-1 shown in FIG. 12.

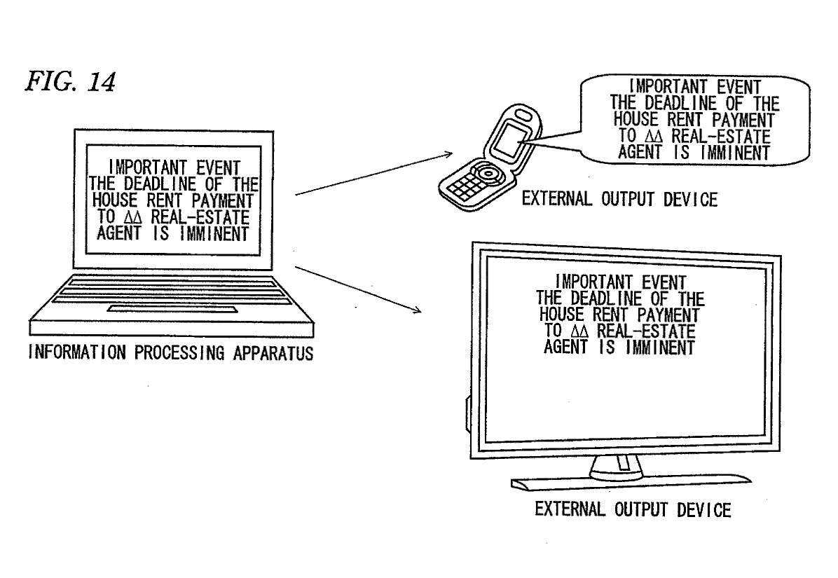

FIG. 14 shows a display example-3 of the information processing apparatus 100 according to the embodiment. This example is such that the information processing apparatus 100 displays a message on the display device via the CPU 105 to send a notice of an event on a scheduled event notification date in the future event management table 102 which is managed by the event occurrence predicting program 108. In this example, the event as a subject of notification has importance “high” and hence is sent to plural external output devices 116.

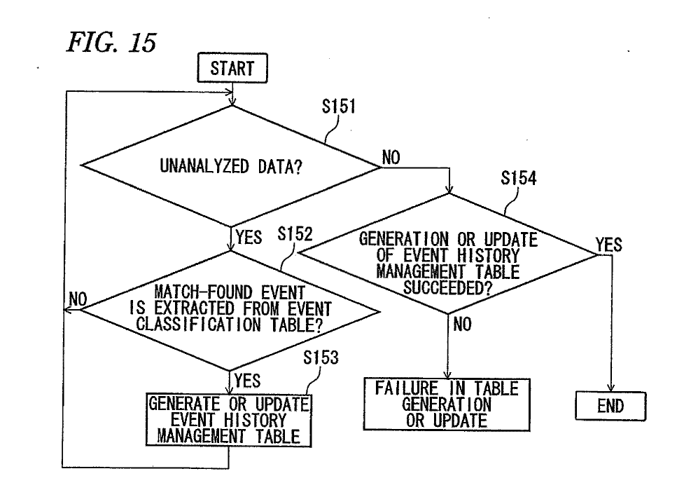

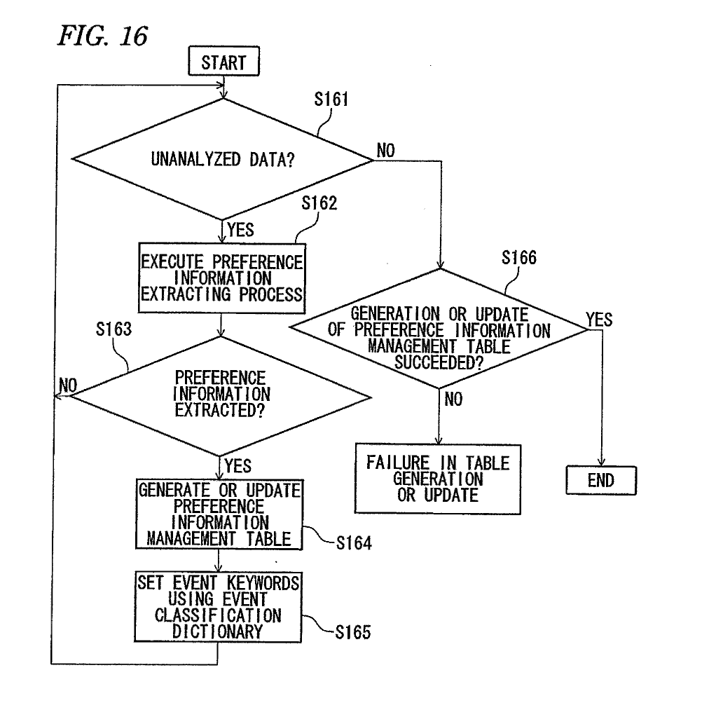

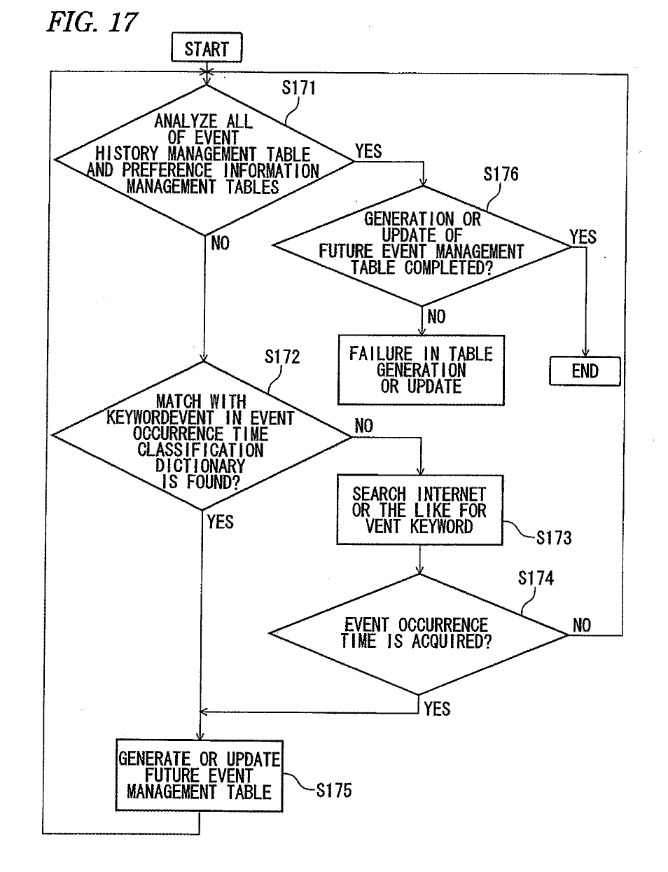

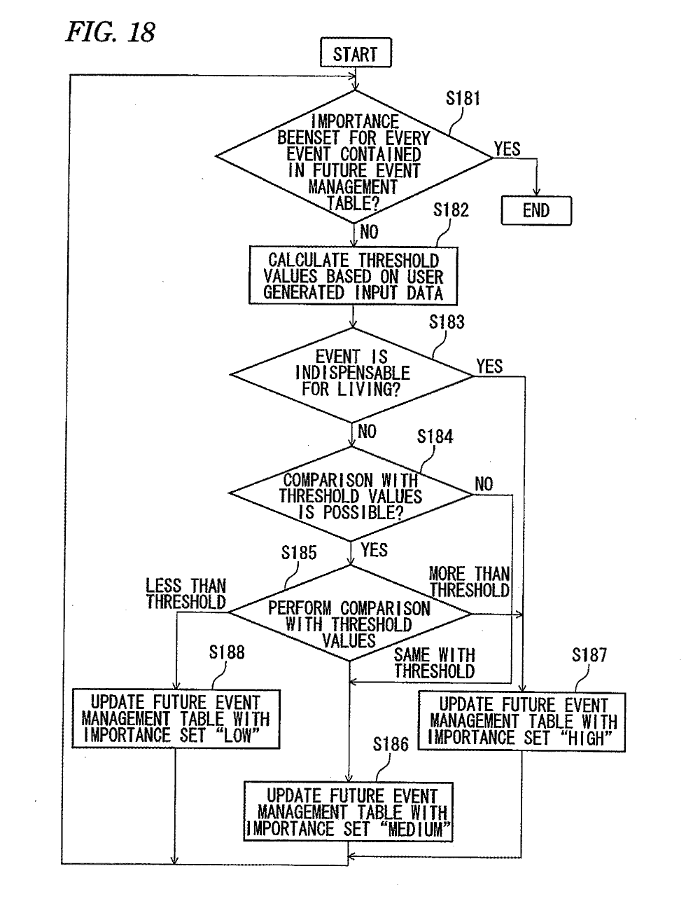

FIG. 15 is a flowchart of a process for generating or updating a/the event history management table 104 in the embodiment. FIG. 16 is a flowchart of a process for generating or updating a/the preference information management table 103 in the embodiment. FIG. 17 is a flowchart of a process for generating or updating a/the future event management table in the embodiment. FIG. 18 is a flowchart of a process for calculating event importance and updating the future event management table 102 in the embodiment. The details of these processes will be described in the following section “Operation of the embodiment.”

### Operation of the Embodiment

An example of an operation of the embodiment will be outlined with reference to FIG. 2.

First, at step S210, it is determined whether or not an end instruction has been received from the user. The operation is finished if an end instruction has been received. If no end instruction has been received, it is determined at step S201 whether two hours have elapsed or not. When determined that two hours have elapsed, then it is determined at step S202 whether or not user-generated data has been input newly. When determined that data has been input newly, at step S203 an/the event history management table 104 is generated or updated based on the user-input data. At step S204, a/the preference information management table 103 is generated or updated based on the user-input data. At step S205, a/the future event management table 102 is generated or updated based on the event history management table 104 and the preference information management table 103. At step S206, importance of the event is calculated based on the user-input data and the preference information management table 103 and the future event management table 102 is updated. At step S207, related information is acquired based on the preference information management table 103 and the future event management table 102 is updated accordingly. When determined at step S208 that there exist an event and related information of which the user needs to be notified, at step S209 the user is notified of the future event and the related information.

The details of the operation will be described below.

Upon being powered on, at step S210 the information processing apparatus 100 determines whether or not an end instruction has been received from the user. When determined that no end instruction has been received, then it is determined regularly whether or not new data has been input by the user.

In the embodiment, whether new data has been input or not is determined every two hours. To this end, first, the information processing apparatus 100 determines at step S201 whether two hours have elapsed or not. When determined that two hours have elapsed, then it is determined at step S202 whether or not user-generated data has been input newly. When determined that the user has input new data from the external storage device 115, the network 117, or the like, at step S203 the event extracting program 107 extracts events that are found in the user-input data and generates or updates an/the event history management table 104.

A process for extracting events and generating or updating an event history management table 104 will be described below with reference to FIG. 15. First, at step S151, it is determined whether or not user-generated input data is unanalyzed data. If the input data is unanalyzed data, it is analyzed by one of the following methods A) to G) etc. and character strings are extracted. The event classification dictionary (see FIG. 3) which is held by the event extracting program 107 is searched for the extracted character strings. If an extracted character string coincides with a character string contained in the event classification dictionary, the event keyword that corresponds to the match-found character string in the event classification dictionary is extracted.

A) The body and the title of a mail are acquired from the network 117 via the external input/output device 114 and subjected to a character analysis, whereby character strings are extracted.

B) A moving image or a photograph taken by the user is acquired from the external storage device 115 via the external input/output device 114 and the content of each event is acquired from metadata or analyzed by an image analysis, whereby character strings are extracted.

C) The contents of a diary written by the user are acquired and subjected to a character analysis, whereby character strings are extracted.

D) An input history of an Internet information sharing service (e.g., blog or profile service) from the network 117 via the external input/output device 114 and subjected to a character analysis, whereby character strings are extracted.

E) A purchase history or a use history of transportation tickets (train tickets) is acquired from the network 117 via the external input/output device 114 and analyzed, whereby character strings are extracted.

F) A goods or ticket purchase history is acquired from the network 117 via the external input/output device 114 and analyzed, whereby character strings are extracted.

G) A getting on/off station history is acquired from a cell phone, a credit card, or the like that incorporates a non-contact IC chip via the non-contact information reading device 113 and analyzed, whereby character strings are extracted.

At step S152, it is determined whether or not a match-found event has been extracted from the event classification dictionary. If a match-found event has been extracted from the event classification dictionary, at step S153 an/the event history management table 104 is generated or updated based on a corresponding event keyword extracted from the event classification dictionary.

If no match-found event has been extracted from the event classification dictionary, an event history management table 104 is not generated or the event history management table 104 is updated and the next user-generated input data is analyzed.

When all input data that have been generated by the user have been analyzed, when determined at step S154 that the generation or update of an/the event history management table 104 succeeded at least once (S154: yes), the process is finished normally.

When all input data that have been generated by the user have been analyzed, when determined at step S154 that the generation or update of an/the event history management table 104 did not succeed even once (S154: no), it means that the generation or update of an/the event history management table 104 has failed and hence the process is finished abnormally. The abnormal ending means that no corresponding event has been found in the event classification dictionary, and usually the process is finished as it is. However, if this state occurs consecutively a prescribed number of times, a certain event may be set.

A specific example will be described below. Assume the following. Occurrence of an event that a mail indicating completion of reservation for hotel A was received on 2008/6/1, occurrence of an event that a mail indicating completion of an order of Father's Day gift from department store A was received on 2008/6/10, and occurrence of an event that a mail indicating completion of payment of a house rent was received from real-estate agent A on 2008/6/20 have become known by analyzing mails. Occurrence of an event that charging was done at station A on 2009/6/25 and occurrence of an event that charging was done at station C on 2009/6/27 have become known from a getting on/off history of the user that is acquired by the non-contact information reading device 113. Occurrence of an event that the user saw a concert held at town A on 2008/6/26 has become known from photograph data that is input from the external storage device 115.

The above events are analyzed and the event classification table (see FIG. 3) is searched for extracted character strings. As a result, event keywords “reservation of hotel” are extracted based on the character string “reservation for hotel A,” event keywords “Father's Day” are extracted based on the character string “order of Father's Day gift,” event keywords “payment of house rent” are extracted based on the character string “payment of a house rent,” event keywords “tour, going out” are extracted based on the character string “charging was done at station A,” an event keyword “concert” is extracted based on the character string “concert”, and event keywords “tour, going out” are extracted based on the character string “charging was done at station C.” The event history management table 104 (see FIG. 4) is updated accordingly at step S153.

Returning to FIG. 2, at step S204 a/the preference information management table 103 is generated or updated based on user-input data.

A process for extracting user preference information and generating or updating a/the preference information management table 103 will be described below with reference to FIG. 16. First, at step S161, it is determined whether or not user-generated input data is unanalyzed data. If the input data is unanalyzed data, at step S162 a preference information extracting process is executed.

Preference information is extracted by analyzing the input data by one of the following methods A) to G) etc.:

A) A moving image or a photograph taken by the user is acquired from the external storage device 115 via the external input/output device 114 and colors that appear in preference subject items etc. at high probabilities are found by an image analysis or from metadata, whereby preference information (favorite colors) of the user is extracted.

B) The numbers of times of reproduction by the user of pieces of music and contents are acquired, whereby preference information (favorite pieces of music and contents) of the user is extracted.

C) A history of search words that were input to Internet search pages are acquired from the network 117 via the external input/output device 114 and subjected to a character analysis, whereby preference information of the user is extracted.

D) A goods or ticket Internet purchase history are acquired from the network 117 via the external input/output device 114 and analyzed, whereby preference information of the user is extracted.

E) A getting on/off station history is acquired from a cell phone, a credit card, or the like that incorporates a non-contact IC chip via the non-contact information reading device 113 and the numbers of times of getting-on/off are analyzed, whereby preference information of the user is extracted.

At step S163, it is determined whether preference information has been extracted. When determined that preference information has been extracted, at step S164 a/the preference information management table 103 is generated or updated based on the extracted preference information.

At step S165, event keywords are set using the event classification dictionary (see FIG. 3). More specifically, the event classification dictionary (held by the event extracting program 107) is searched for character strings that are contained in the generated or updated preference information management table 103. If a character string contained in the preference information management table 103 coincides with a character string contained in the event classification dictionary, the event keyword that corresponds to the match-found event in the event classification dictionary is extracted and set in the preference information management table 103.

For a character string in the preference information management table 103 with which no match is found, “none” is set in the column “event keywords.”

If no preference information is found at step S162, a/the preference information management table 103 is not generated or updated and the next user-generated input data is analyzed.

When all input data that have been generated by the user have been analyzed, when determined that the generation or update of an/the preference information management table 103 succeeded at least once (S166: yes), the process is finished normally.

When all input data that have been generated by the user have been analyzed, when determined that the generation or update of an/the preference information management table 103 did not succeed even once (S166: no), it means that the generation or update of an/the preference information management table 103 has failed and hence the process is finished abnormally.

A specific example will be described below. Assume that an Internet search history is acquired from the network 117 via the external input/output device 114 and analyzed, whereby “firework,” “sale,” “yukata,” and “sushi” are obtained in descending order of the number of appearances among, for example, a prescribed number of latest events for search words. The preference information management table-1 (see FIG. 5) is thus generated. Then, the event classification dictionary (see FIG. 3) is searched for the search word character strings contained in the preference information management table-1, whereby event keywords “fireworks, festival” are extracted based on the character string “firework,” an event keyword “sale” is extracted based on the character string “sale,” and event keywords “fireworks, festival” are extracted based on the character string “yukata.” The preference information management table-1 is updated accordingly. Since no character string that coincides with the character string “sushi” is found in the event classification dictionary, “none” is set in the column “event keywords” of the preference information management table-1.

Assume that a getting on/off station history is acquired via the non-contact information reading device 113 and analyzed, whereby “station A,” “station B,” “station C,” and “station D” are obtained in descending order of the use frequency. The preference information management table-2 (see FIG. 6) is thus generated. Then, the event classification dictionary (see FIG. 3) is searched for the station name character strings contained in the preference information management table-2, but no match is found with any character string. Therefore, “none” is set in every entry of the column “event keywords” of the preference information management table-2.

Assume that user-input photograph data is acquired from the external storage device 115 via the external input/output device 114 and analyzed, whereby “red,” “yellow,” “black,” and “white” are obtained in descending order of the probability of occurrence. The preference information management table-3 (see FIG. 7) is thus generated. Then, the event classification dictionary (see FIG. 3) is searched for the color character strings contained in the preference information management table-3, but no match is found with any character string. Therefore, “none” is set in every entry of the column “event keywords” of the preference information management table-3.

Returning to FIG. 2, at step S205, the event occurrence predicting program 108 predicts future event occurrence times based on the event history management table 104 (see FIG. 4) and the preference information management tables 103 (see FIGS. 5-7) and generates or updates a/the future event management table 102.

A process for generating or updating a/the future event management table 102 will be described with reference to FIG. 17. First, at step 171, it is determined whether all of the event history management table 104 (see FIG. 4) and the preference information management tables 103 (see FIGS. 5-7) have been analyzed or not. If not all of the event history management table 104 and the preference information management tables 103 have been analyzed yet, to determine whether or not event keywords contained in the event history management table 104 and the preference information management tables 103 are of periodically occurring events, the event occurrence time classification dictionary (see FIG. 8) which is held by the event occurrence predicting program 108 is searched for those event keywords.

At step S172, it is determined whether or not each event keyword contained in the event history management table 104 and the preference information management tables 103 coincides with an event keyword contained in the event occurrence time classification dictionary. If a match is found, at step S175 a/the future event management table 102 is generated or updated according to the event occurrence cycle and the future event occurrence time that correspond to the match-found event keyword in the event occurrence time classification dictionary. At this time, “not set” is set in the columns “importance” 703 and “related information” 704 of the future event management table 102.

If no match is found between an event keyword contained in the event history management table 104 or the preference information management tables 103 and any event keyword contained the event occurrence time classification dictionary, at step S173 the network 117 or the like is searched for the event keyword via the external input/output device 114.

At step S174, it is determined whether an event occurrence time has been acquired or not by searching the network 117 for an event occurrence time corresponding to the event keyword. If an effective event occurrence time has been acquired, at step S175 the future event management table 102 is updated.

If no effective event occurrence time has been acquired by searching the network 117 for an event occurrence time corresponding to the event keyword, a/the future event management table 102 is not generated or updated.

When the analysis of all of the event history management table 104 and the preference information management tables 103 has completed, if the generation or update of an/the future event management table 102 has completed at least once (step S176), the process is finished normally.

When the analysis of all of the event history management table 104 and the preference information management tables 103 has completed, if the generation or update of an/the future event management table 102 has not completed even once, it means that the generation or update of an/the future event management table 102 has failed and hence the process is finished abnormally.

A specific example will be described below. By searching the event occurrence time classification dictionary (see FIG. 8), the event occurrence predicting program 108 finds that an event occurrence cycle “once a year” and a future event generation time “third Sunday of June” correspond to the entry “Father's Day” in the column “event keywords” 402 of the event history management table 104 (see FIG. 4). The actual date of the third Sunday of June, 2009 is obtained from a calendar that is stored in the event occurrence predicting program 108. Since the third Sunday of June, 2009 is Jun. 21, 2009, the future event management table 102 (see FIG. 9) is updated so that the thus-acquired date is entered into the column “predicted event occurrence date (year/month/day)” 901.

Likewise, by searching the event occurrence time classification dictionary, the event occurrence predicting program 108 finds that an event occurrence cycle “once a month” and a future event generation time “around the preceding payment date” correspond to the entry “payment of house rent” in the column “event keywords” 402 of the event history management table 104. A preceding event occurrence date “Jun. 20, 2008” is known from the column “event occurrence date (year/month/day)” 400 of the event history management table 104. Therefore, the future event management table 102 (see FIG. 9) is updated so that the “Jun. 20, 2009” is entered into the column “predicted event occurrence date (year/month/day)” 901.

The event occurrence predicting program 108 searches the Internet for event keywords in the event history management table 104 for which no match is found any event keyword in the event occurrence time classification dictionary. In this specific example, no match is found with the event keywords “tour, going out” and “concert” in the event history management table 104. And no match is found with the event keywords “firework, festival” and “sale” in the preference information management table-1 (see FIG. 5). Event occurrence times are acquired by searching the Internet for those event keywords.

To obtain an effective search result, each event keyword is searched for by taking into consideration the preference information of the user that is contained in the preference information management tables 103. For example, “firework, festival” is searched for also using the station name “station A” which has the first rank in the preference information management table-2 (see FIG. 6). Furthermore, when the Internet is searched, keywords such as “date of holding, start date, date and time” that would facilitate determination of an event occurrence time are also used. Information “sale of tickets for viewing of a firework display to be held at town A on Jun. 25, 2009” is acquired by searching the Internet using keywords “firework, festival,” “station A,” “date of holding, start date, date and time”. Likewise, for the event keyword “concert,” information “holding of a concert at town A on Jun. 26, 2009” is acquired by searching the Internet using keywords “concert,” “station A,” “date of holding, start date, date and time.” The column “predicted event occurrence date (year/month/day)” 901 of the future event management table 102 (see FIG. 9) is updated accordingly. If a search result does not include date information such as year/month/day, the future event management table 102 (see FIG. 9) is not updated for this future event.

The main purpose of a predicted event occurrence date that is predicted by the event occurrence predicting program 108 is to prevent the event from being forgotten, and hence its precise date need not be presented to the user. For example, the user may be notified of an event earlier than its predicted occurrence time and correct it to an accurate date if necessary. In this example, the user is notified 20 days before an actual event occurrence date. Therefore, the scheduled event notification date of the notification event “Father's Day” is “2009/6/1.”

Returning to FIG. 2, at step S206, importance levels of the events contained in the future event management table 102 are calculated based on user-input data and the preference information management tables 103 and the future event management table 102 is updated based on the calculated importance levels.

A process for calculating importance levels of events and updating the future event management table 102 will be described below with reference to FIG. 18.

First, at step S181, it is determined whether or not importance has been set for every event contained in the future event management table 102.

At step S182, threshold values for calculation of importance is calculated based on user-generated input data. For example, an average is determined for each of such items as the number of photographs, the transportation fee, the amount of payment, and the number of written messages by analyzing event-related data that have been input by the user. Threshold values are set at levels that are higher and lower than the average by 30%, respectively. An event whose value is larger than the plus 30% level is given importance “high,” an event whose value is between the two threshold values is given importance “medium,” and an event whose value is smaller than the minus 30% level is given importance “low.”

If a notification event relates to payment that is indispensable for the living of the user such as payment of any of heating and lighting expenses (e.g., electricity, gas, and heating oil charges), a water charge, or a house rent, at step S183 the notification event is determined an event that is indispensable for living and hence importance “high” is set.

If the notification event is determined not indispensable for living and if effective input data generated by the user exists for the notification event and comparison with the threshold values is possible (S184: yes), at step S185 importance is determined through comparison with the threshold values.

Among the events contained in the future event management table 102, importance “medium” is given to events for which comparison with the threshold values cannot be made because of absence of effective input data generated by the user, events relating to the national holidays that are set by the National Holidays Law, events relating to yearly events that relate to historical events, and events each of which does not belong to any category. Examples of such events are Father's Day, Children's Day, Respect-for-the-Aged Day, and Christmas Day.

A specific example will be described below. Since the event “Father's Day” contained in the column “notification event” 1002 of the future event management table 102 (see FIG. 10) is a yearly event, it is given importance “medium,” which is entered into the column, “importance” 1003 of the future event management table 102 (see FIG. 10). Since the event “payment of house rent” is an event that is indispensable for living, it is given importance “high”, which is entered into the column “importance” 1003 of the future event management table 102 (see FIG. 10). Since the event “information of holding of concert at town A” is not an event that is indispensable for living and user-generated input data can be compared with the threshold values, importance is calculated using the threshold values. Assume that the average of the numbers of photograph data produced for respective events by the user is equal to 20. Threshold values are set at 26 (20 plus 30%) and 14 (20 minus 30%). Importance “high” is given if the number of photograph data is larger than 26, importance “medium” is given if the number of photograph data is between 14 and 26, and importance “low” is given if the number of photograph data is smaller than 14. Since the number of photographs that were taken during viewing of the concert that was held at town A and corresponds to the event contained in the event history management table 104 (see FIG. 4) is equal to 30, the event “information of holding of concert at town A” is given importance “high” and the column “importance” 1003 of the future event management table 102 (see FIG. 10) is updated accordingly.

Finally, since the event “information of sale of tickets for viewing of firework display to be held at town A” does not belong to any category, it is given importance “medium” and the column “importance” 1003 of the future event management table 102 (see FIG. 10) is updated accordingly.

Returning to FIG. 2, at step S207 the related information acquiring program 111 searches the network 117 for information relating to events of which the user is to be notified and the preferences of the user via the external input/output device 114, acquires such information, and updates the future event management table 102. Example manners of acquisition of related information will be described below.

The related information acquiring program 111 searches the Internet using, as a search word, a notification event (1002) contained in the future event management table-2 (see FIG. 10) via the CPU 105 and the external input/output device 114, and stores a search result in the column “related information”-1004 of the future event management table-2 (see FIG. 10).

The related information acquiring program 111 searches the Internet using, as search words, a combination of a notification event (1002) contained in the future event management table-2 (see FIG. 10) and first-rank items of the preference information management table 103 (see FIGS. 5-7) via the CPU 105 and the external input/output device 114, and stores a search result in the column “related information” 1004 of the future event management table-2 (see FIG. 10).

A specific example will be described below. For example, a search result of the notification event “information of sale of tickets for viewing of firework display to be held in town A” and a search result of a combination of the notification events “information of sale of tickets for viewing of firework display to be held in town A” and “red” are entered into the column “related information” 1004 as shown in the future event management table-3 (see FIG. 11). Also for the other items, the related information acquiring program 111 searches the Internet via the external input/output device 114 and enters search results into the column “related information” 1004 as shown in the future event management table-3 (see FIG. 11).

Returning to FIG. 2, at step S208, it is determined whether an event and related information of which the user is to be notified exist or not. When determined such event and related information exist, at step S209 the event occurrence predicting program 108 notifies an external output device 116 of the event and the related information that is contained in the column “related information” 1104 of the future event management table-3 (see FIG. 11) via the CPU 105.

As for the manner of notification of related information, it is possible to notify the user of only an event first and to display related information later (see FIG. 13).

A specific example will be described below. An external output device 116 is notified of an event with power-on timing on a day contained in the column scheduled event notification date (year/month/day)” 1100 of the future event management table-3 (see FIG. 11). If power-on does not occur on the day contained in the column scheduled event notification date (year/month/day)” 1100, the external output device 116 is notified of the event when power-on occurs for the first time after the scheduled event notification date. If first power-on occurs after its predicted event occurrence date, the external output device 116 need not be notified of the event. However, it is preferable to notify an external output device 116 of, for example, an indispensable event even after its predicted event occurrence date.

When the importance (1103) of a notification event (1102) contained in the future event management table-3 (see FIG. 11) is “high,” plural external output devices 116 are informed of the notification event. Furthermore, larger characters than in the case where the importance is “medium” or “low” are used together with an effect sound, music, or the like, and the re-notification interval is set shorter. The user is thus informed of the predicted occurrence of the event more impressively.

In this example, when the importance is “high,” the notification interval is set at one day and two or more external output devices 116 are informed of the re-notification event (see FIG. 14). When the importance is “medium,” the notification interval is set at three days and one external output device 116 is informed of the re-notification event. When the importance is “low,” the re-notification interval is set at five days and one external output device 116 is informed of the notification event.

Only importance is employed in the embodiment, urgency may also be taken into account.

### Other Embodiments and Modifications

The method of extracting an event history via the external input/output device 114 that is described in the embodiment does not restrict the event history extracting method. For example, an event history may be set freely by a user operation.

The operation starting method of the embodiment in which whether or not new data has been input by the user is checked every two hours does not restrict the operation of the apparatus. Operation may be started with timing that new data is input from by user or an instruction is received from the user.

The future event occurrence predicting method of the invention does not restrict the future event occurrence predicting method. For example, a future occurring event may be set freely by a user operation.

The method of extracting preference information of the user via the external input/output device 114 that is described in the embodiment does not restrict the preference information extracting method. For example, preference information may be set freely by a user operation or a preference may be predicted based on a profile that is registered by the user in advance.

The content, the notification timing, and the notifying module of a message for notifying the user of an event that is described in the embodiment does not restrict the event notifying method. A message may be presented by other methods such as voice output.

The algorithm for determining importance of an event that is described in the embodiment does not restrict the method for calculating a predicted future event occurrence time. For example, importance may be determined freely by a user operation.

The timing and the means for notifying the user of related information which are described in the embodiment do not restrict the related information notifying method. The user may be notified of related information simultaneously with an event or by other methods such as voice output.

The method of extracting an event history via the external input/output device 114 which is described in the embodiment does not restrict the event history extracting method. An event history may be set freely by a user operation.

As described above, in the embodiment, a future occurring event is extracted automatically from photographs taken by the user or mail transmission/reception data. The user need not register a date and time of an event.

The embodiment provides an advantage that the means for automatically extracting a future occurring event from photographs taken by the user or a mail transmission/reception data, determining its importance, and performing its notification makes it possible to eliminate complicated work the user has been required to do to manage events by himself or herself.

Furthermore, presenting the user with information that relates to a future event occurrence time allows the user to encounter various goods or new events.

By automatically extracting a future occurring event, determining its importance, and performing its notification, the user is allowed to be freed from complicated work for managing events by himself or herself.

According to a component for also presenting the user with related information that relates to an event and conforms to preference information of the user in notifying the user of the event allows the user to encounter new goods or events that the user has not been aware of. This provides an enhanced advertisement effect because the user would be interested in the event around the time of its occurrence.

(1) The event extracting program 107 takes in user-generated input data or a communication history, extracts a periodically occurring event from the thus-taken-in input data or communication history, and generates or updates an event history management table 104.

(2) The preference information extracting program 109 extracts preference information of the user from user-generated input data or a communication history and generates or updates a preference information management table 103.

(3) The event occurrence predicting program 108 predicts a future event occurrence time based on event occurrence time information that is acquired by searching the network 117 via the external input/output device 114, an event history, preference information, etc., and generates or updates a future event management table 102.

(4) The event importance calculating program 110 calculates importance of an event based on user-generated input data, a communication history, and preference information, and updates the future event management table 102.

(5) The related information acquiring program 111 acquires related information that relates to a future event and conforms to preference information of the user by searching the network 117 via the external input/output device 114, and updates the future event management table 102.

(6) The event occurrence predicting program 108 notifies an external output device 116 of future occurrence of an event together with related information by a method that is suitable for its importance.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An event notifying apparatus comprising:
an extracting module configured to extract a periodically occurring event from acquired input data or a communication history;
a predicting module configured to predict a future occurrence time of the event based on a cycle of occurrence of the event extracted by the extracting module; and
a notifying module configured to notify an external device about the event based on the future occurrence time predicted by the predicting module.

2. The apparatus of claim 1 further comprising:
a preference extracting module configured to extract preference information of a user from acquired input data or a communication history,
wherein the predicting module is configured to predict a future occurrence time of the event further based on event occurrence time information acquired externally over a network by a search or the preference information.

3. The apparatus of claim 2 further comprising:
an importance calculating module configured to calculate importance of the event based on acquired input data, a communication history, or the preference information,
wherein the notifying module is configured to notify the external device about the event further based on the importance of the event.

4. The apparatus of claim 2 further comprising:
a related information receiving module configured to receive related information over a network by a search, the related information relating to the event and the preference information,
wherein the notifying module is configured to notify the external device about the event and the related information.

5. An event notifying method comprising:
extracting a periodically occurring event from received input data or a communication history;
predicting a future occurrence time of the event based on a cycle of occurrence of the extracted event; and
notifying an external device about the event based on the predicted future occurrence time.
